(19) United States
(12) Patent Application Publication
(10) Pub. No.: US 2011/0320088 A1
(43) Pub. Date: Dec. 29, 2011

(54) System and method for displaying power status of hybrid vehicle

(75) Inventors: Ki Tae Eom, Hwaseong (KR); Jae Hoon Cho, Suwon (KR); Teh Hwan Cho, Anseong (KR)

(73) Assignees: Kia Motors Corporation, Seoul (KR); Hyundai Motor Company, Seoul (KR)

(21) Appl. No.: 12/927,598

(22) Filed: Nov. 18, 2010

(30) Foreign Application Priority Data
Jun. 29, 2010 (KR) 10-2010-0062159

(51) Int. Cl. G06F 17/00; B60Q 1/00

(52) U.S. Cl. 701/29; 340/455; 180/65.21; 903/903

(57) ABSTRACT

The present invention features a system and method for displaying a power status of a hybrid vehicle, which can provide more extensive and detailed information such as a power status of a motor and an engine, a battery charge/discharge status, an operational status of an engine brake, etc. during running of the hybrid vehicle. In embodiments of the present invention, the power ratio of the motor and the engine is displayed using a bar graph including a bar and a separator. In further embodiments, the status information of the motor and the engine, such as a battery charge/discharge status by a motor, an operational status of an engine brake, etc., is displayed in different colors, thereby allowing a driver to visually and easily recognize the displayed information.

### CROSS-REFERENCE TO RELATED APPLICATION

This application claims under 35 U.S.C. §119(a) priority to and the benefit of Korean Patent Application No. 10-2010-0062159 filed Jun. 29, 2010, the entire contents of which are incorporated herein by reference.

### BACKGROUND

1. Technical Field

The present invention generally relates to a hybrid vehicle. More particularly, the present invention relates to a system and method for displaying a power status of a hybrid vehicle to allow a driver to visually and easily compare and recognize the power status of a motor and an engine during running of the vehicle.

2. Background Art

A hybrid vehicle, in a broad sense is a vehicle driven by efficiently using at least two different types of power sources. In most cases, the term is associated with a hybrid vehicle that is driven by an engine such as an internal combustion engine that generates a rotational force by burning a fuel (fossil fuel such as gasoline), and an electric motor which generates a rotational force using the electric power of a battery.

Such a hybrid vehicle when driven in an electric vehicle (EV) mode is directed to a pure electric vehicle mode using only the power of the electric motor (drive motor or traction motor). In the hybrid electric vehicle (HEV) mode, which is an auxiliary mode, the rotational force of the engine as a main power source and the rotational force of the drive motor as an auxiliary power source is used to drive the vehicle. In the regenerative braking (RB) mode, the braking energy or inertia energy of the vehicle produced by braking or during driving by inertia, is recovered by power generation of the drive motor which is used to charge the battery.

During starting of the vehicle or during low-speed running, the vehicle is driven only by the electric drive motor. As engine efficiency is lower than the motor efficiency during initial starting, the drive motor with a higher efficiency is used to start the vehicle from the standpoint of fuel efficiency. After starting the vehicle, the engine is driven by a hybrid starter-generator (HSG) to use the engine power and the motor power at the same time.

Such a hybrid vehicle also includes a hybrid control unit (HCU) and a controller for each component constituting the system. Such a hybrid vehicle also includes an engine control unit (ECU) that controls the overall operation of the engine, a motor control unit (MCU) that controls the overall operation of the drive motor, a transmission control unit (TCU) that controls a transmission, a battery management system (BMS) that controls the operation of batteries, and the like.

The HCU is a superior controller that controls the other respective subordinate controllers, selects a drive mode, calculates and outputs engine and motor torques, and controls the overall operation of the vehicle. The other controllers are connected together through a high-speed CAN communication line based on the HCU to transmit and receive information to and from each other such that the superior controller transmits commands to the subordinate controllers.

In order to control the torque of the hybrid vehicle, a driver demand torque is calculated to which a driver's intention is reflected. An operation point determination unit of the HCU calculates an optimal operation point of the engine and the drive motor to perform a torque distribution control of the engine and the drive motor such that the vehicle is driven in an optimal mode at the driver demand torque.

As the driver demand torque corresponds to a sum of the engine torque and the motor torque, the operation point determination unit of the HCU calculates torque command values of the engine and the drive motor based on the optimal operation points. The HCU's operation point determination unit also outputs torque commands to the engine and the drive motor such that torques corresponding to the torque commands are output by the engine and the drive motor, thereby satisfying the driver demand torque.

For example, when high engine power is required as the driver fully depresses an accelerator pedal, the engine power is maintained at an optimal operation condition and, in case where the power from engine is not sufficient to meet the driver's demand, the deficient power is assisted by the motor. The combined power of the engine and the motor (battery discharge and torque assist by the motor) satisfies the power that the driver demanded and so the vehicle is driven under conditions where the engine efficiency is high

When the engine is operated in a low power region where the efficiency is low; as the driver slightly depresses the accelerator pedal, the engine power is increased to a range where the efficiency is high and the engine power other than the power required to drive the vehicle is used to generate electricity in the drive motor. This generated electricity from the drive motor, is used to charge the battery (i.e., battery charged by the power generation of the motor).

In addition to basic information such as vehicle speed, engine speed, amount of fuel, distance traveled, distance remaining, etc., which are provided by a conventional engine driven vehicle, vehicle status information such as battery state, fuel efficiency, motor assist, battery state of charge, eco driving mode, etc. are provided to an instrument cluster of the hybrid vehicle. One or more display devices are provided to display or provide such basic information, the operational status of the hybrid system and the vehicle status information, so as to allow a driver to perform a safe and economical driving of the vehicle.

However, such a conventional hybrid vehicle does not provide other detailed information such as whether the vehicle is being driven by the motor or the engine, the power status of the electric motor and the engine, the operational status of an engine brake, etc., which would be beneficial to a driver.

It thus would be desirable to provide a system and methods for displaying a power status of a hybrid vehicle. It would be particularly desirable to provide such a system and method that would allow a driver to visually and easily compare and recognize the power status of a drive motor and engine while the vehicle is operating.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

The present invention features a system and method for displaying a power status of a hybrid vehicle. Such systems and methods advantageously provide more extensive and detailed information such as a power status of a motor and an engine as power sources, a battery charge/discharge status, an operational status of an engine brake, etc. during the operation or running of the hybrid vehicle.

More particularly, such systems and methods of the present invention are such as to display status information of a motor and an engine, such as a battery charge/discharge status by a motor (motor's charge/discharge mode), an operational status of an engine brake, etc., to allow a driver to visually and easily recognize the status information.

According to one aspect of the present invention, there is featured a system for displaying a power status of a hybrid vehicle, that includes a hybrid control unit, a display control unit, and display unit. The hybrid control unit transmits a power ratio of a motor and an engine, and status information of the motor and the engine. The display control unit outputs a control signal to display information based on the power ratio of the motor and the engine and the status information of the motor and the engine received from the hybrid control unit. The display unit is controlled by the control signal output from the display control unit to display the power ratio of the motor and the engine and the status information of the motor and the engine.

In particular embodiments, the display unit displays the information using a bar graph including a bar indicating the total power and a separator. The separator is configured so as to separate the total power into the ratio of motor power and the ratio of engine power. The separator also moves along the bar according to the power ratio of the motor and the engine such that the ratio of the motor power and the ratio of the engine power are distinguished in the bar based on the separator.

In another embodiment, the display unit displays a bar area indicating the ratio of motor power and a bar area indicating the ratio of engine power, which are separated by the separator. More particularly, the bar areas are in different colors based on the current status of the motor and the engine such that a driver can distinguish the current status by the different colors.

In still another embodiment, the status information of the motor is information indicative of a motor's charge or discharge mode where a battery is charged by the motor or discharged.

In yet another embodiment, the status information of the engine is information indicative of an operational status of an engine brake.

In a further aspect of the present invention, there is featured a system for displaying a power status of a hybrid vehicle having a motor and engine, where such a system includes a display control unit and a display unit. The display control unit is configured and arranged so as to output a control signal to display information based on input signal representative of a power ratio of the motor and the engine and status information of the motor and the engine. The display unit is configured so as to display the power ratio of the motor and the engine and the status information of the motor and the engine responsive to the control signal output from the display control unit. In a further embodiment, such a system further includes a hybrid control unit that is configured and arranged so as to transmit the power ratio of the motor and the engine and the status information of the motor and the engine.

In further embodiments, the display unit is configured so as to display the information in the form of a bar graph, the bar graph including a bar indicating the total power and a separator separating the total power into the ratio of motor power and the ratio of engine power. Such a display unit is further configured so the separator moves along the bar according to the power ratio of the motor and the engine such that the ratio of the motor power and the ratio of the engine power are distinguished in the bar based on the separator.

In yet further embodiments, the display unit is configured so as to display a bar area indicating the ratio of motor power and a bar area indicating the ratio of engine power, which are separated by the separator, in different colors based on the current status of the motor and the engine.

In yet further embodiments, the status information is information indicative of a motor's charge or discharge mode where a battery is charged by the motor or discharged for the motor; or information indicative of an operational status of an engine brake for the engine. In more particular embodiments, the status information is at least one of (a) information indicative of a motor's charge or discharge mode where a battery is charged by the motor or discharged for the motor; or (b) information indicative of an operational status of an engine brake for the engine.

In yet further aspects of the present invention, there is featured a method for displaying a power status of a hybrid vehicle having a motor and an engine. Such a method includes controlling, at a display control unit, a display unit so the display unit receives a power ratio of the motor and the engine and status information of the motor and the engine displays the information. Such a method further includes allowing the display unit to display the power ratio of the motor and the engine using a bar graph and, at the same time, display the status information of the motor and the engine in the bar graph so to be distinguished by different colors.

In further embodiments, such a method includes transmitting a power ratio of a motor and an engine and status information of the motor and the engine to the display control unit.

In yet further embodiments, such methods further includes calculating the power ratio of the motor and the engine using the following relationships, where A, B and C are predetermined tuning factors.

$$Ratio of Motor Power ( \% ) = \frac{A \times [ Motor Power ]}{B \times [ Motor Power ] + C \times [ Engine Power ]} \times 100 ( \% )$$

$$( Motor Power = Driving Motor Power + HSG Power \\ Ratio of Engine Power ( \% ) = 100 - Ratio of Motor Power ( \% ) .$$

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Other aspects and embodiments of the present invention are discussed infra.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

For a fuller understanding of the nature of the present invention as well as the above and other features of the present invention, reference is made to the following detailed description taken in conjunction with the accompanying drawing figures. In the figures, reference numbers refer to the same or equivalent parts of the present invention throughout the several figures of the drawing.

FIG. 1 is a block diagram showing one configuration of a system for displaying a power status in accordance with the present invention.

FIGS. 2 to 6 are various illustrative views of an exemplary display unit illustrating a method for displaying a power status in accordance with the present invention.

The reference numerals set forth in the Drawings includes reference to the following elements as further discussed below:

| | |
|---|---|
| 11: hybrid control unit | 12: display control unit |
| 13: display unit | 14: bar |
| 15: separator | |

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION

Hereinafter reference will now be made in detail to various embodiments of the present invention, examples of which are illustrated in the accompanying drawings and described below. It is understood that the following description is not intended to limit the scope of the present invention. It shall be understood that the scope of the invention shall embrace various alternatives, modifications, equivalents and other embodiments, which may be included within the spirit and scope of the invention as defined by the appended claims.

The present invention provides a system and method for displaying a power status of a hybrid vehicle. Such systems and methods of the present invention provide more extensive and detailed information; such as a power status of a motor and an engine as power sources, a battery charge/discharge status, an operational status of an engine brake, etc. during running or operation of the hybrid vehicle.

That is, the system and method of the present invention are such that the status information of the motor and the engine can be displayed. Such information includes, but is not limited to, the motor's charge/discharge mode, the operational status of the engine brake, etc. as well as the power ratio of the motor and the engine, which are used to drive the vehicle.

The systems and methods of the present invention also are such so as to display the power ratio of the motor and the engine with respect to the total power using a bar graph and a separator and, at the same time, displays the status information of the motor and the engine such as the motor's charge/discharge mode, the operational status of the engine brake, etc., to be distinguished by different colors. In this way, driver can visually and easily recognize the status information of the vehicle.

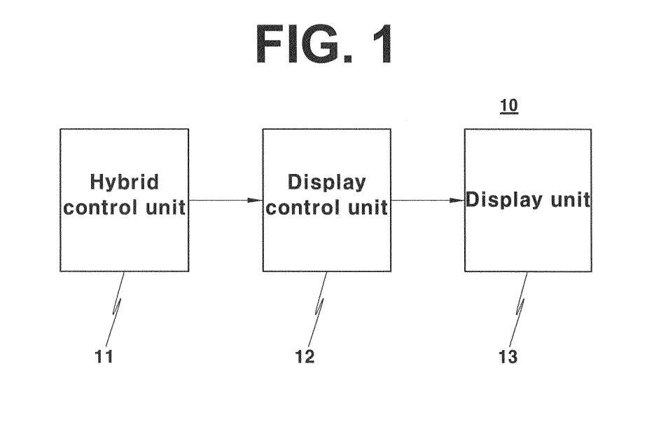

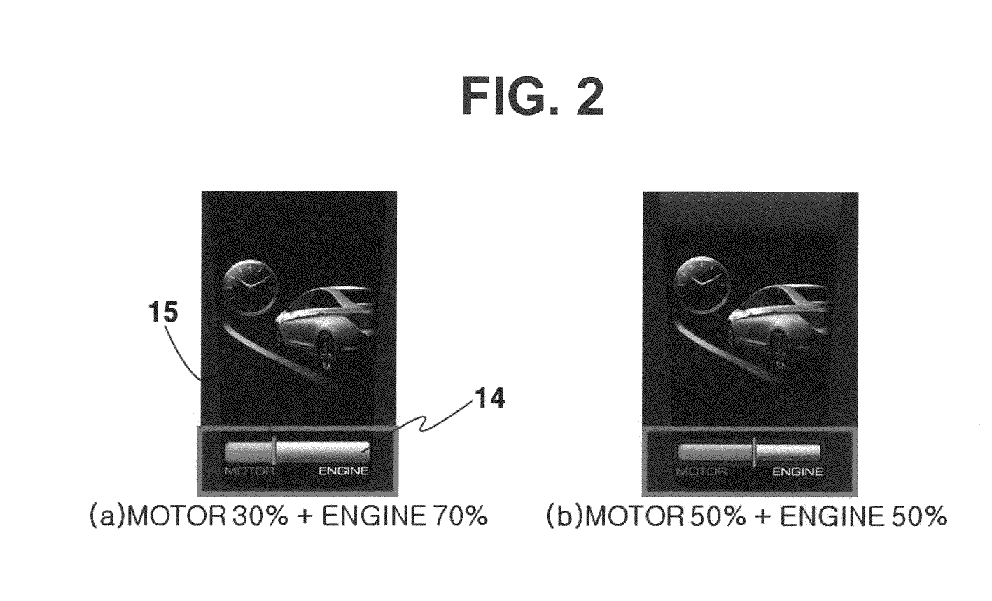

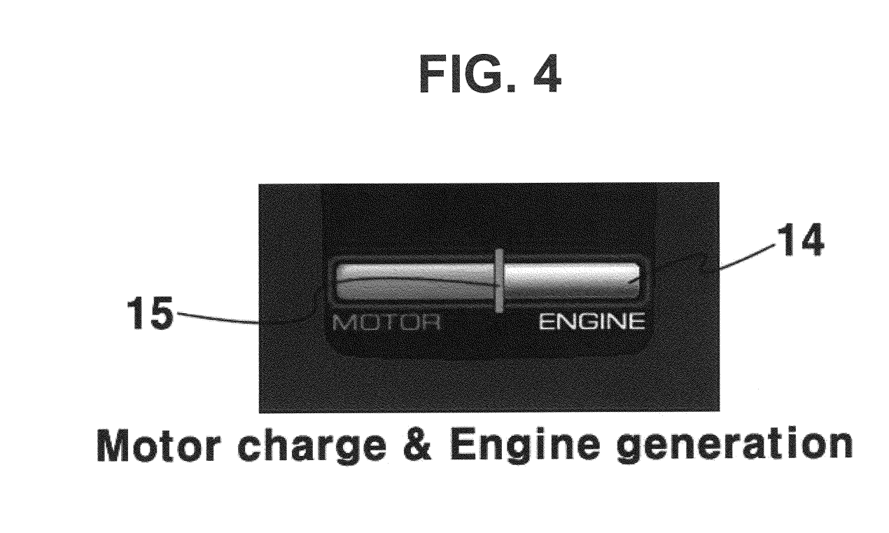

Referring now to FIG. 1 there is shown a block diagram of a system 10 that can display a power status in accordance with the present invention. As to FIGS. 2 to 6, these are various illustrative views of an exemplary display unit 13 illustrating the methodology for displaying a power status in accordance with the present invention.

Such a system 10 for displaying the power status in accordance with the present invention includes a hybrid control unit 11, a display control unit 12 and a display unit 13.

The hybrid control unit 11 transmits a power ratio of a motor and an engine with respect to the total power and status information of the motor and the engine. In particular, such information is transmitted to the display control unit. The display control unit 12 is configured so as to output a control signal to control the display of information based on the power ratio of the motor and the engine and the status information of the motor and the engine received from the hybrid control unit 11. The display unit 13 is configured so as to be controlled by the control signal outputted from the display control unit 12 and so as to display the power ratio of the motor and the engine and the status information of the motor and the engine.

The display unit 13 is any of a number of display devices as are known to those skilled in the art including, but not limited to liquid crystal type of displays. Such display devices are typically configured to generate an image responsive to the control and/or data signals inputted to the display device.

In more particular aspects/embodiments, the display unit is configured so that the power ratio of the motor and the engine is displayed as a bar graph or bar. In this way, the display unit 13 displays the power ratio of the motor and the engine as a bar graph to the driver or vehicle operator. The display unit 13 is further configured so that at the same time, the display unit 13 displays the status information of the motor and the engine in the bar graph to be distinguished by different colors.

In the present invention, the status information of the motor and the engine includes information indicating the motor's charge mode (e.g., engine regeneration, regeneration, etc.) and the motor's discharge mode (e.g., EV, power assist, etc.), in which the battery is charged or discharged by the motor, and information indicating the operational status of the engine brake.

The hybrid control unit 11 is a superior controller used in a typical hybrid vehicle to select a drive mode, calculate and output engine and motor torques, and control the overall operation of the vehicle. In further embodiments, the hybrid control unit 11 is configured to provide the current status information of the motor and the engine such as the power status of the motor and the engine, the motor's charge/discharge mode, the operational status of the engine brake, etc.

Such a hybrid control unit 11 also calculates the power ratio of the motor and the engine with respect to the total power based on the current power level of the engine and that of the motor, which are used to drive the vehicle, and transmits the calculated power ratio to the display control unit 12 through a communication line.

The following are examples of formulas for calculating the power ratio of the motor and the engine with respect to the total power are as follows.

$$\begin{matrix}Ratio of Motor Power ( \% ) = \frac{A \times [ Motor Power ]}{B \times [ Motor Power ] + C \times [ Engine Power ]} \times 100 ( \% ) \\ ( Motor Power = Driving Motor Power + HSG Power & [ Formula 1 ] \\ Ratio of Engine Power ( \% ) = 100 - Ratio of Motor Power ( \% ) & [ Formula 2 ]\end{matrix}$$

In formula 1, the motor power represents the sum of powers of the drive motor (traction motor) and a hybrid starter-generator (HSG), and A, B and C represent predetermined tuning factors. Such predetermined tuning factors are typically determined or calculated by vehicle test.

The hybrid control unit 11 outputs signals based on the current status of the motor and the engine, such as a signal indicative of the motor's charge/discharge mode and a signal indicative of the operational status of the engine brake, and transmits the signals to the display control unit 12.

The following Table 1 shows examples of the power ratio, the motor status, and the engine status of each powertrain mode, transmitted from the hybrid control unit 11.

TABLE 1

| | | Motor | Engine |
|---|---|---|---|
| PT Mode | Power Ratio | Charge | Charge |
| 1. Vehicle Stop | 100% | 0 | 0 |
| 2. EV Propulsion | To be calculated | 0 | 0 |
| 3. Power Assist | To be calculated | 0 | 0 |
| 4. Engine Only Propulsion | To be calculated | 0 | 0 |
| 5. Engine Generation | To be calculated | 1 | 0 |
| 6. Regeneration | To be calculated | 1 | 0 |
| 7. Engine Brake | 0% | 0 | 1 |
| 8. Power Reserve | To be calculated | 1 | 0 |
| 9. Engine Generation/ | To be calculated | 1 | 0 |
| Motor Drive | | | |
| 10. Engine Generation/ | To be calculated | 1 | 0 |
| Regeneration | | | |
| 11. Engine Brake/Regeneration | To be calculated | 1 | 1 |

As shown in Table 1, the hybrid control unit 11 calculates the power ratio (%) of the motor and the engine using formulas 1 and 2, except for the vehicle stop mode (1) where there is no driving power, and the engine brake mode (7) where the engine brake is operated, and transmits the calculated power ratio to the display control unit 12.

In the mode where there is no driving power, the hybrid control unit 11 transmits a predetermined power ratio. For example, the hybrid control unit 11 transmits the ratio of motor power of 100% in the vehicle stop mode (where the driving power of the engine is 0%) and the ratio of engine power of 0% in the engine brake mode (where the driving power of the engine is 100%). Here, the power ratio of the motor and the engine does not represent the actual driving power.

Moreover, when the battery is discharged by the operation of the motor in the EV propulsion mode (2) where the vehicle is driven only by the motor power, the HEV mode, i.e., the power assist mode (3), where the vehicle is driven by both the motor power and the engine power, and the engine only propulsion mode (4) where the vehicle is driven only by the engine power, the hybrid control unit 11 transmits a signal indicative of the motor's discharge mode (i.e., “0” in the Motor Charge of Table 1) to the display control unit 12.

The hybrid control unit 11 transmits a signal indicative of the motor's charge mode (i.e., “1” in the Motor Charge of Table 1) to the display control unit 12, when (a) the battery is charged with electric power generated by the motor in the engine generation mode (5) where the engine power is used by the drive motor (traction motor/HSG) for generation, (b) the regeneration mode (6) where the braking energy is recovered by the motor), (c) the power reserve mode (8), (d) the engine generation/motor drive mode (9) where the engine power is used by the drive motor for generation and the vehicle is driven by the drive motor (traction motor/HSG), (e) the engine generation/regeneration mode (10), and (f) the engine brake/regeneration mode (11).

In addition, the hybrid control unit 11 transmits a signal indicative of the operational status of the engine brake. That is, as shown in Table 1, when the engine brake is operated in the engine brake mode and the engine brake/regeneration mode, the hybrid control unit 11 transmits a signal indicative of the engine brake's operation (i.e., “1” in the Engine Brake of Table 1) to the display control unit 12. When the engine brake is not being operated, the hybrid control unit 11 transmits a signal indicating that the engine brake is not operated (i.e., “0” in the Engine Brake of Table 1) to the display control unit 12.

Therefore, the display control unit 12 receives the signal indicative of the motor's charge/discharge mode and the signal indicative of the operational status of the engine brake as well as the power ratio of the motor and the engine from the hybrid control unit 11.

As indicated herein, the display control unit 12 controls the operation of the display unit 13 to display the corresponding information based on the signal received from the hybrid control unit 11. In particular illustrative embodiments, the display unit 13 of the present invention is an instrument cluster of the vehicle and, in this case, the display control unit 12 is a cluster controller (having a microprocessor). In further embodiments, the display control unit 12 is any of a number of digital processing circuits known to those skilled in the art, which is configured so as to perform the methods or processes described herein.

As shown in FIG. 2, the display unit 13 displays the power status of the motor and the engine in the form of a bar graph under the control of the display control unit 12. The bar graph includes a bar 14 indicating the total power and a separator 15 that moves along the bar 14 to separate the total power into the ratio of motor power and the ratio of engine power, which are being used to drive the vehicle, according to its position. In more particular embodiments, the display unit 13 is configured so as to display the bar and moving separator responsive to the control signal(s) from the display control unit 12.

In sum the display unit 13 displays the total power using a single bar 14, in which the separator 15 moves along the bar 14 to separately display the power ratio of the motor and the engine based on its position.

As the total power of the motor and the engine is 100%, the ratio of motor power is displayed on one side of the bar 14 and the ratio of engine power is displayed on the other side of the bar 14 based on the separator 15.

Since the hybrid control unit 11 transmits a predetermined power ratio of the motor and the engine, i.e., a value of 100%, in the vehicle stop mode and the engine brake mode shown in Table 1, the separator 15 is located at the right end of the bar 14 in the vehicle stop mode where the ratio of motor power is 100% or at the left end of the bar 14 in the engine brake mode where the ratio of engine power is 100%.

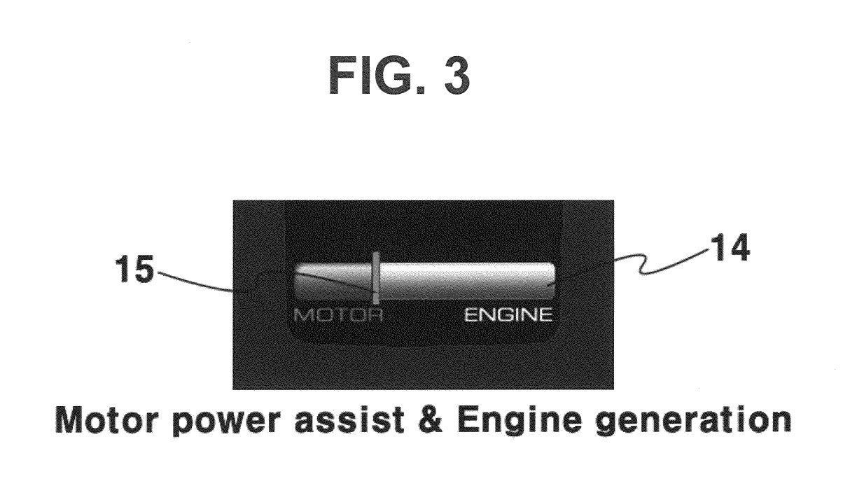

In addition, as shown in FIGS. 3 to 6, the status of the motor and the engine is distinguished by different colors. That is, the bar areas at both sides separated by the separator 15 such as the bar area indicating the ratio of motor power (i.e., the left area of the bar in the figure) and the bar area indicating the ratio of engine power (i.e., the right area of the bar in the figure) are displayed in different colors based on the current status of the motor and the engine such that the driver can distinguish the information.

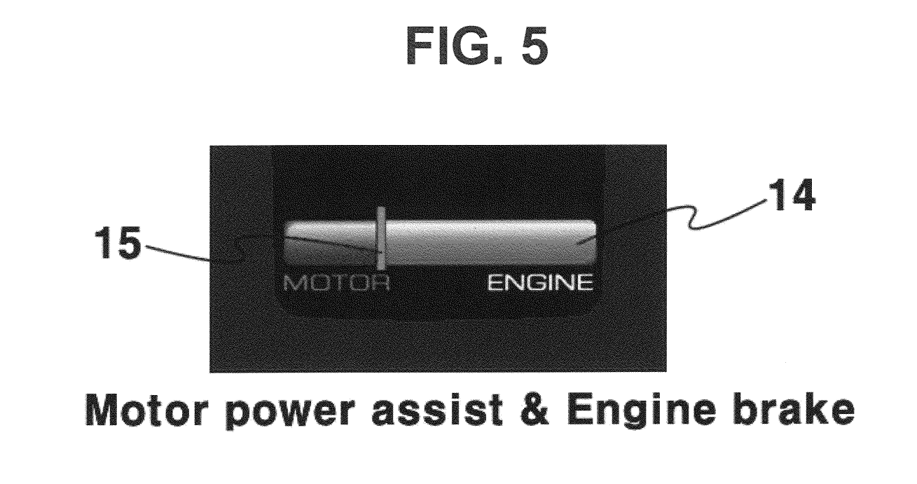

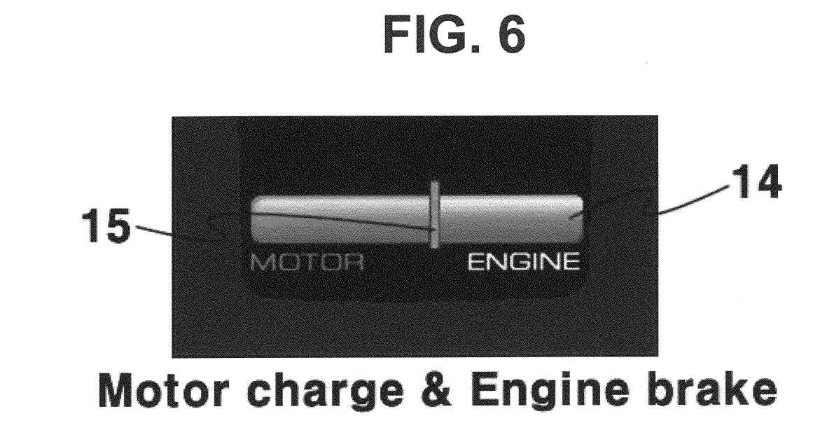

For example, during the motor's charge mode, the bar area indicating the ratio of motor power is displayed in green (see FIGS. 2, 4, and 6) and, during the motor's discharge mode, the bar area indicating the ratio of motor power is displayed in blue (see FIGS. 3 and 5). During the engine generation mode, the bar area indicating the ratio of engine power is displayed in white (see FIGS. 2, 3, and 4) and, during the engine brake mode, the bar area indicating the ratio of engine power is displayed in red (see FIGS. 5 and 6).

As described above, according to the system and method for displaying the power state of the present invention, the power ratio of the motor and the engine transmitted from the hybrid control unit 11 is graphically displayed in the form of a bar or bar graph, and thus the driver can visually and easily recognize the current power status.

As the status information of the hybrid vehicle such as the power status of the motor and the engine, the battery charge/discharge status, the operational status of the engine brake, etc. is/are displayed in different colors, the driver can easily and accurately recognize the current status information.

In addition, as the charge/discharge mode, the operational status of the engine brake, etc. as well as the current power status are displayed, it is possible to allow the driver to recognize the operation of the motor as a power source other than the engine and, at the same time, to efficiently exhibit the characteristics of the hybrid vehicle.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A system for displaying a power status of a hybrid vehicle, the system comprising:
a hybrid control unit for transmitting a power ratio of a motor and an engine and status information of the motor and the engine;
a display control unit for outputting a control signal to display information based on the power ratio of the motor and the engine and the status information of the motor and the engine received from the hybrid control unit; and
a display unit controlled by the control signal output from the display control unit to display the power ratio of the motor and the engine and the status information of the motor and the engine.

2. The system of claim 1, wherein the display unit displays the information using a bar graph including a bar indicating the total power and a separator separating the total power into the ratio of motor power and the ratio of engine power, the separator moving along the bar according to the power ratio of the motor and the engine such that the ratio of the motor power and the ratio of the engine power are distinguished in the bar based on the separator.

3. The system of claim 2, wherein the display unit displays a bar area indicating the ratio of motor power and a bar area indicating the ratio of engine power, which are separated by the separator, in different colors based on the current status of the motor and the engine such that a driver can distinguish the current status by the different colors.

4. The system of claim 1, wherein the status information is at least one of (a) information indicative of a motor's charge or discharge mode where a battery is charged by the motor or discharged for the motor or (b) information indicative of an operational status of an engine brake for the engine.

5. The system of claim 3, wherein the status information is at least one of (a) information indicative of a motor's charge or discharge mode where a battery is charged by the motor or discharged for the motor, or (b) information indicative of an operational status of an engine brake for the engine.

6. A method for displaying a power status of a hybrid vehicle, the method comprising the steps of:
transmitting at a hybrid control unit, a power ratio of a motor and an engine and status information of the motor and the engine;
controlling, at a display control unit, a display unit to receive the power ratio of the motor and the engine and the status information of the motor and the engine from the hybrid control unit and display the information; and
allowing the display unit to display the power ratio of the motor and the engine using a bar graph and, at the same time, display the status information of the motor and the engine in the bar graph to be distinguished by different colors.

7. The method of claim 6, wherein said allowing the display unit to display includes allowing the display unit to display the information using a bar graph including a bar indicating the total power and a separator separating the total power into the ratio of motor power and the ratio of engine power, the separator moving along the bar according to the power ratio of the motor and the engine such that the ratio of the motor power and the ratio of the engine power are distinguished in the bar based on the separator.

8. The method of claim 7, wherein said allowing the display unit to display includes allowing the display unit to display a bar area indicating the ratio of motor power and a bar area indicating the ratio of engine power, which are separated by the separator, in different colors based on the current status of the motor and the engine such that a driver can distinguish the current status by the different colors.

9. The method of claim 6, wherein the status information is at least one of (a) information indicative of a motor's charge or discharge mode where a battery is charged by the motor or discharged for the motor or (b) information indicative of an operational status of an engine brake for the engine.

10. The method of claim 8, wherein the status information is at least one of (a) information indicative of a motor's charge or discharge mode where a battery is charged by the motor or discharged for the motor or (b) information indicative of an operational status of an engine brake for the engine.

11. The method of claim 6, further comprising the step of having the hybrid control unit calculate the power ratio of the motor and the engine using the following formulas 1 and 2:
$$Ratio of Motor Power ( \% ) = \frac{A \times [ Motor Power ]}{B \times [ Motor Power ] + C \times [ Engine Power ]} \times 100 ( \% ) \\ ( Motor Power = Driving Motor Power + HSG Power \qquad [ Formula 1 ]$$
wherein A, B and C represent predetermined tuning factors;
Ratio of Engine Power (%)=100−Ratio of Motor Power (%). [Formula 2]

12. A system for displaying a power status of a hybrid vehicle having a motor^{s} and engine, the system comprising:
a display control unit for outputting a control signal to display information based on input signal representative of a power ratio of the motor and the engine and status information of the motor and the engine; and
a display unit configured to display the power ratio of the motor and the engine and the status information of the motor and the engine responsive to the control signal output from the display control unit.

13. The system of claim 12, further comprising a hybrid control unit being configured to transmit the power ratio of the motor and the engine and the status information of the motor and the engine;

14. The system of claim 12, wherein the display unit is configured so as to display the information in the form of a bar graph, the bar graph including a bar indicating the total power and a separator separating the total power into the ratio of motor power and the ratio of engine power, wherein the display unit is further configured so the separator moves along the bar according to the power ratio of the motor and the engine such that the ratio of the motor power and the ratio of the engine power are distinguished in the bar based on the separator.

15. The system of claim 14, wherein the display unit is configured so as to display a bar area indicating the ratio of motor power and a bar area indicating the ratio of engine power, which are separated by the separator, in different colors based on the current status of the motor and the engine.

16. The system of claim 12, wherein the status information is at least one of (a) information indicative of a motor's charge or discharge mode where a battery is charged by the motor or discharged for the motor; or (b) information indicative of an operational status of an engine brake for the engine.

17. The system of claim 13, wherein the status information is at least one of (a) information indicative of a motor's charge or discharge mode where a battery is charged by the motor or discharged for the motor; or (b) information indicative of an operational status of an engine brake for the engine.

18. A method for displaying a power status of a hybrid vehicle having a motor and an engine, the method comprising:
controlling, at a display control unit, a display unit so the display unit receives a power ratio of the motor and the engine and status information of the motor and the engine displays the information; and
allowing the display unit to display the power ratio of the motor and the engine using a bar graph and, at the same time, display the status information of the motor and the engine in the bar graph so to be distinguished by different colors.

19. The method of claim 6, further comprising the step(s) of:
transmitting a power ratio of a motor and an engine and status information of the motor and the engine to the display control unit.

20. The method of claim 6, further comprising the step of
calculating the power ratio of the motor and the engine using the following relationships, where A, B and C are predetermined tuning factors:
$$Ratio of Motor Power ( \% ) = \frac{A \times [ Motor Power ]}{B \times [ Motor Power ] + C \times [ Engine Power ]} \times 100 ( \% )$$
$$( Motor Power = Driving Motor Power + HSG Power \\ Ratio of Engine Power ( \% ) = 100 - Ratio of Motor Power ( \% ) .$$
